(19) United States
(12) Patent Application Publication
(10) Pub. No.: US 2009/0231300 A1
(43) Pub. Date: Sep. 17, 2009

(54) Methods and apparatus for improved electrical connection for touch screen display devices

(75) Inventor: David Michael Kyle, Decatur, GA (US)

Correspondence Address: PAUL W. MARTIN, NCR CORPORATION, LAW DEPT., 1700 S. PATTERSON BLVD., DAYTON, OH, 45479-0001, US

(73) Assignee: NCR Corporation, Dayton, OH (US)

(21) Appl. No.: 12/047,985

(22) Filed: Mar. 13, 2008

(51) Int. Cl. G06F 3/045

(52) U.S. Cl. 345/174

(57) ABSTRACT

Systems and techniques for providing an electrical connection for a touch screen display sensor. A substrate is fabricated with vias passing through the substrate, and a suitably thin film conductive coating applied to a touch area. Traces, suitably thick film silver frit traces, are placed on the substrate, with a trace extending from a corner of the touch area to a respective via, and including an annular ring around an opening of the via. A conductive pin is secured in each via, with each pin being soldered to the annular ring surrounding the opening of the via in which the pin is secured. The touch screen sensor is then suitably laminated with a protective covering, mounted in a frame, and mounted in a display device in such a way that the pins make contact with a connector of the display device.

### FIELD OF THE INVENTION

The present invention relates generally to improved touch screen displays. More particularly, the invention relates to an arrangement for providing improved electrical interconnection for touch screen sensors.

### BACKGROUND OF THE INVENTION

Touch screen display devices have long been employed in a wide variety of applications, such as employee assisted and self service retail checkouts, medical kiosks, automotive devices, such as global positioning systems, for example, and numerous other applications. A touch screen device typically involves a control circuit, mounted on a printed circuit board along with a display device such as a liquid crystal display (LCD), and a touch screen sensor electrically connected to the control circuit. A touch screen device may typically comprise a glass or other insulating substrate coated with a conductive material configured so that current flows are established in the conductive material and a touch by a user causes current flows through the conductive material. Typically, the touch is to a protective covering layer rather than the conductive material itself. The display device employs a touch screen controller to sense and respond to these current flows.

A touch screen device typically includes traces that carry currents from selected areas of the touch screen, such as the corners of the touch areas, to selected points chosen for providing contact to the touch screen controller. The currents are conducted along the top side of the glass substrate, that is, the side facing the user. The controller is typically deployed on the underside of the substrate, that is, the side facing away from the user In such a configuration, the current flows must be conveyed from the top side of the glass substrate to the controller on its underside in order for the currents to provide information to the controller.

### SUMMARY OF THE INVENTION

A system according to one aspect of the invention addresses these issues, as well as others, by providing for a connector for a touch screen sensor that is integrated into the substrate itself suitable for providing electrical contact with a connector on a touch screen controller, such as an elastomeric connector. A sensor includes a substrate of glass or other suitable material, with the substrate including a plurality of vias. The substrate suitably includes a conductive coating on its top side, that is, the side that is to face a user, and traces are placed on the substrate, with a trace running to each via. Connecting pins are secured in the vias, so that connectivity is provided from the top side to the underside by way of the connecting pins. A protective layer is suitably laminated to the top side of the touch sensor, over the conductive layer, and a similar protective layer may also suitably be laminated to the underside of the touch sensor. The touch sensor is mounted so that the pins contact a connector, such as an elastomeric connector that is positioned at the underside of the substrate when the touch screen sensor is in use. The connector is in turn connected to a touch screen controller attached to a printed circuit board providing a mounting for the controller and supporting other devices, such as a liquid crystal display (LCD).

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a view of a touch screen including electrically conductive elements carrying current along a top surface of the touch screen according to an aspect of the present invention;

FIG. 2 illustrates a detailed view of selected elements of the touch screen of FIG. 1;

FIGS. 3 illustrates an additional view of elements of the touch screen of FIG. 1, showing pins oriented for insertion into the touch screen;

FIG. 4 illustrates a pin for insertion into a via of a touch screen for providing electrical contact to a touch screen controller;

FIG. 5 illustrates a side view of a pin inserted into a touch screen;

FIG. 6 illustrates a view of a touch screen device according to an aspect of the present invention; and

FIG. 7 illustrates a process of touch screen sensor connection according to an aspect of the present invention.

### DETAILED DESCRIPTION

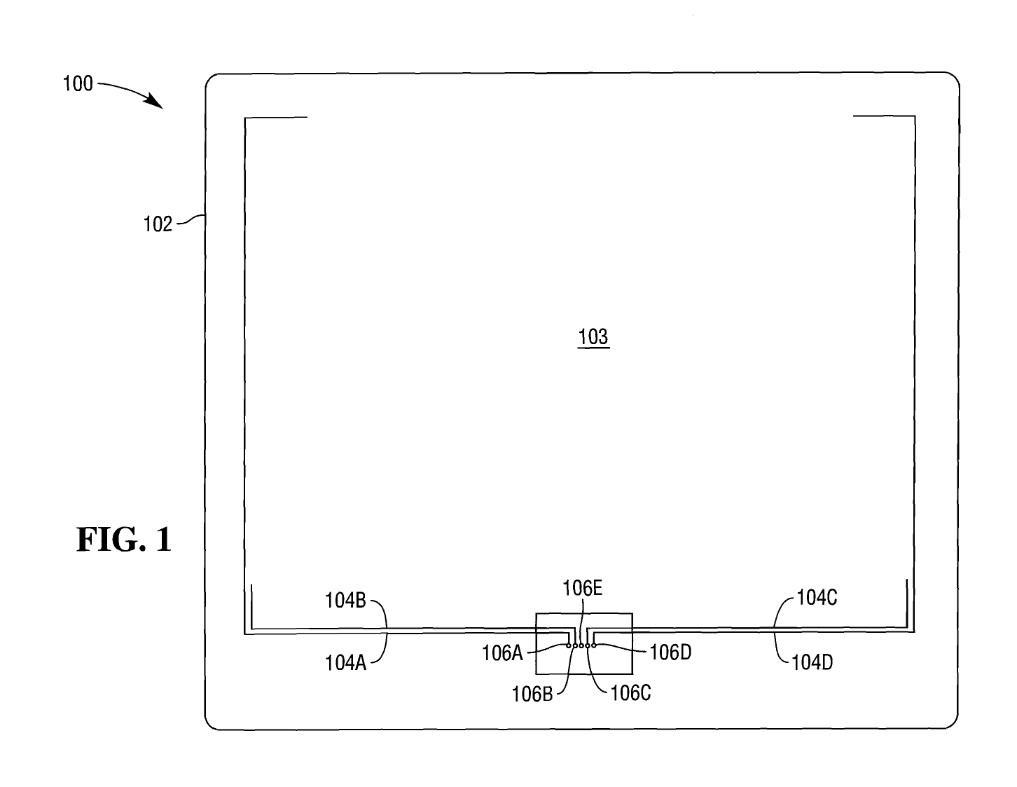

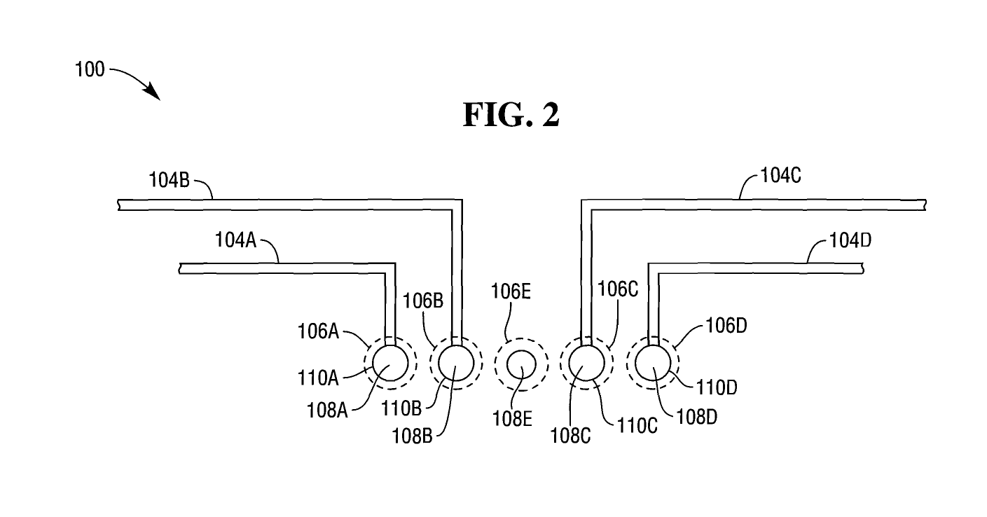

FIG. 1 illustrates a touch screen sensor 100 according to an aspect of the present invention. The sensor 100 comprises a glass substrate 102, which may suitably be coated with a transparent conductive material which is not visible here, but which may suitably be an antimony-tin oxide coating or another appropriate coating material of the type normally used in touch screen sensors. If desired, the back of substrate 102 may also be coated with a conductive material, so as to provide for reduction in electrical noise. When the user touches the sensor 100 in a touch sensitive area 103, a current flow is established through the coating. Portions of the current are conducted by traces 104A-104D to contact points 106A-106D. The contact points 106A-106D are shown more clearly in FIG. 2 and discussed in greater detail below. The contact points 106A-106D take the form of vias through the substrate 102, surrounded by annular rings, The rings provide for electrical connectivity between the traces 104A-104D and pins that may be placed in the vias. The pins suitably provide for an electrical connection between the traces at the front of the substrate 102 to elements, such as a touch screen controller, that may be placed at the back of the substrate 102, so that the current flow through the vias is passed through the substrate 102 to the elements at the back of the substrate 102 by way of the pins. An additional optional contact point 106E is also shown here. The contact point 106E is used if a rear coating for noise reduction is employed, and provides electrical contact between front and rear conductive coatings on the substrate 102.

FIG. 2 illustrates additional details of a portion of the touch screen 100, showing the contact points 106A-106D, as well as the optional contact point 106E. Portions of the traces 104A-104D can also be seen. The contact points comprise vias 108A-108D, surrounded by annular rings 110A-110D respectively. The annular rings 110A-110D are connected to the traces 104A-104D, respectively. The optional contact point 106E can also be seen, comprising an optional via 106E. There is no visible annular ring surrounding the optional via 108E, because an annular ring surrounds the via 108E at the rear of the substrate 102. A conductive pin may be inserted in each of the vias 108A-108D, so that a portion of the pin comes in contact with the ring surrounding the via in which the pin is placed. In this way, current flowing through the trace is conveyed to the pin placed in the via surrounded by the annular ring connected to that trace. In addition, a conductive pin may be placed in the via 108E, providing a contact between the front and back coating.

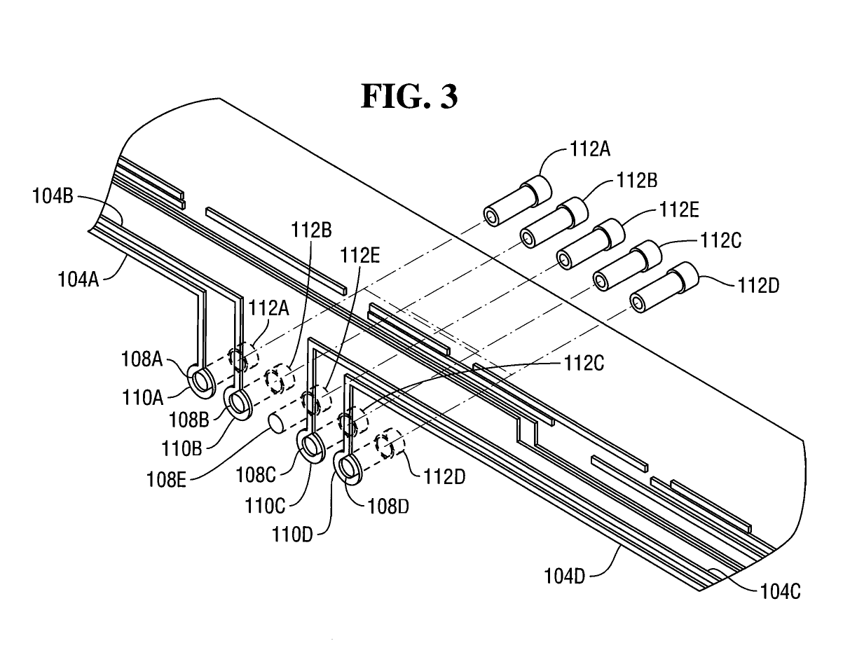

FIG. 3 illustrates a portion of the touch screen 100, showing portions of the traces 104A-104D, the vias 108A-108D, the annular rings 110A-110D, and pins 112A-112D in a process of insertion into the vias 108A-108D. In addition, FIG. 3 illustrates the optional via 108E, and the optional pin 112E. The pins 112A-1121E may suitably be pressed into the vias 108A-108E from the back side of the substrate 102, and secured in place with a small amount of adhesive. The pins 112A-112D may then be soldered to the annular rings 108A-108D, and the pin 112E soldered to an annular ring placed on the rear of the touch screen 100, surrounding the via 108E. An electrical connection is thus achieved through each of the traces 104A-104D, to the respective annular rings 110A-110D, and through the respective pins 112A-112D, so as to create electrically conductive paths from the corners of the touch screen sensor 100 to the reverse side of the sensor 100. In addition, a contact may be made through the pin 112E between the front and rear coatings. Once the pins have been secured, a protective layer may be laminated so as to cover the substrate 102.

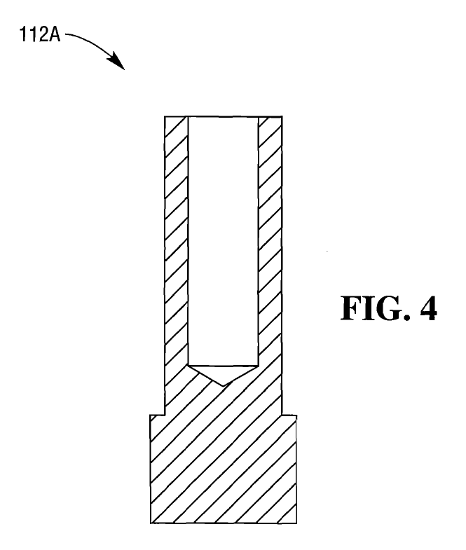

FIG. 4 illustrates further details of the pin 112A, which may suitably be similar to the pins 112B-112D. The pin 112A, as well as the pins 112B-112D, may suitably be a gold plated beryllium copper pin. The particular design and composition of the pin 112A is exemplary, and other pin designs and compositions may be used.

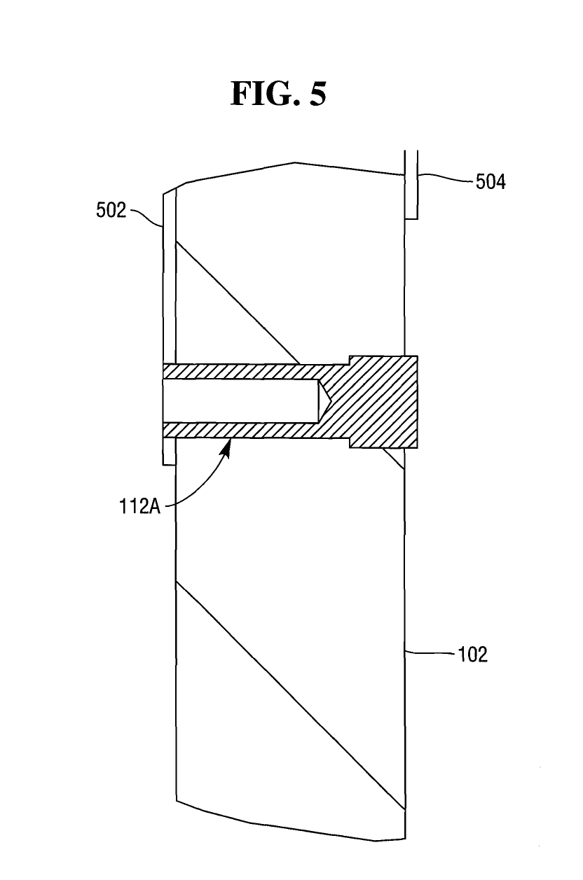

FIG. 5 illustrates a side view of a portion of the substrate 102, showing the pin 112A in place. A thick film pattern 502, comprising a portion of the trace 104A, as well as the annular ring 104A, can be seen on the top side of the substrate 104. A portion 504 of a thin film coating can be seen on the underside of the substrate 102 502 and 504 can be seen on the top side and the underside of the substrate 102, respectively. The pin 112A extends from the underside to the top side of the substrate 102, and may suitably be placed so that it extends 1 mil beyond the substrate 102 in each direction.

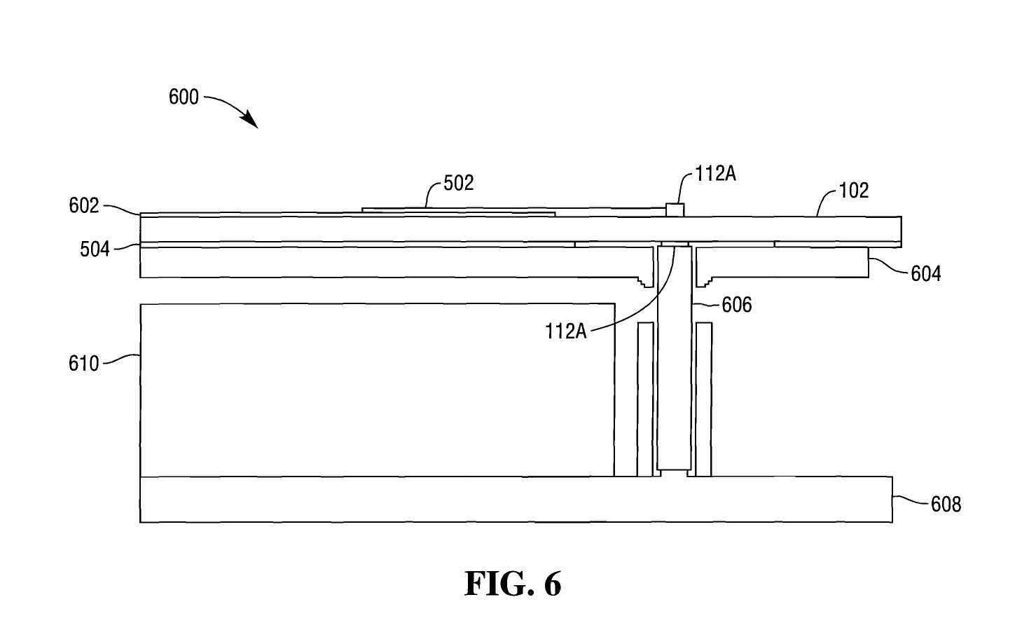

FIG. 6 illustrates a partial side view of a touch screen display device 600 incorporating the touch screen sensor 100. The sensor 100 includes the substrate 102. The thick film pattern 502 and the rear coating 504 can be seen on the front and rear surfaces, respectively, of the substrate 102, and the pin 112A can be seen extending through the via 108A. The rear coating 504 is clear of the pin 112A, because the rear coating 504 is applied so as to be clear of the vias 108A-108D and to surround only the via 108E. A front coating 602 can also be seen. The front coating 602 is clear of the pin 112A, because the front coating 602 is typically used only in the actual touch area of the sensor 100, while the thick film pattern 502 extends to the pin 112A.

The via 108A cannot be clearly seen from the perspective shown here in FIG. 6, but is more clearly visible in FIGS. 1, 2, 3, and 5. A plastic frame 604 can be seen beneath the substrate 102. The frame 604 suitably surrounds or is placed along an outer perimeter of the substrate 102, to provide added rigidity to the touch screen 100. The frame 604 suitably includes an opening to allow contact between the connector 606, which may suitably be an elastomeric connector, and the pin 112A and similar pins. One advantageous implementation of the connector 606 is as a zebra strip elastomeric connector. The frame 604 provides a guide for positioning the elastomeric connector 606 in contact with the pins 112A and similar pins, with the connector being guided along the opening of the frame 604 to the pins. The frame 604 also provides for convenient placement of attachment points for attachment of the sensor 100 in the display device 600.

The connector 606 provides electrical connectivity between the conductive pins, that is, the pins 112A visible here and the other pins, and a touch screen controller 608, here implemented in the form of a printed circuit board supporting appropriate electronic components and connections between the components. A display device, such as a liquid crystal display screen 610, is suitably mounted on and supported by the touch screen controller 608. When a user touches the sensor 100 in the touch area, suitably in response to a prompt displayed on the LCD 610, a current flow is created in the conductive coating 602. This current flow causes current flows in the traces 104A-104D, and these current flows are conducted to the annular rings 110A-110D surrounding the vias 10SA-108D. The current flows are further conducted through the substrate 102 by the pins 112A-12D. In the perspective presented in FIG. 6, as noted above, the pin 112A can be seen to be in contact with the elastomeric connector 606, and the remaining pins 112B-112D are also in contact with the connector 606 when the sensor 100 is installed in the display device 600. Thus, all the current flows are conducted to the connector 606 and to the controller 608 via the connector 606. The controller 608 is thus able to detect the current flows in the pins 112A-112D. Because the current flows depend on the location at which the sensor 100 is touched, the controller 608 is able to determine when and where a touch has occurred and to respond appropriately.

The connection provided by the integrated assembly illustrated here and in the previous drawings allows for a clean and attractive appearance, and thinner borders at the edge of the touch sensor because there is no need to accommodate a wiring harness. A flat sealed front surface is possible, without any gaps that might allow for leakage, and provides for higher reliability and easier serviceability.

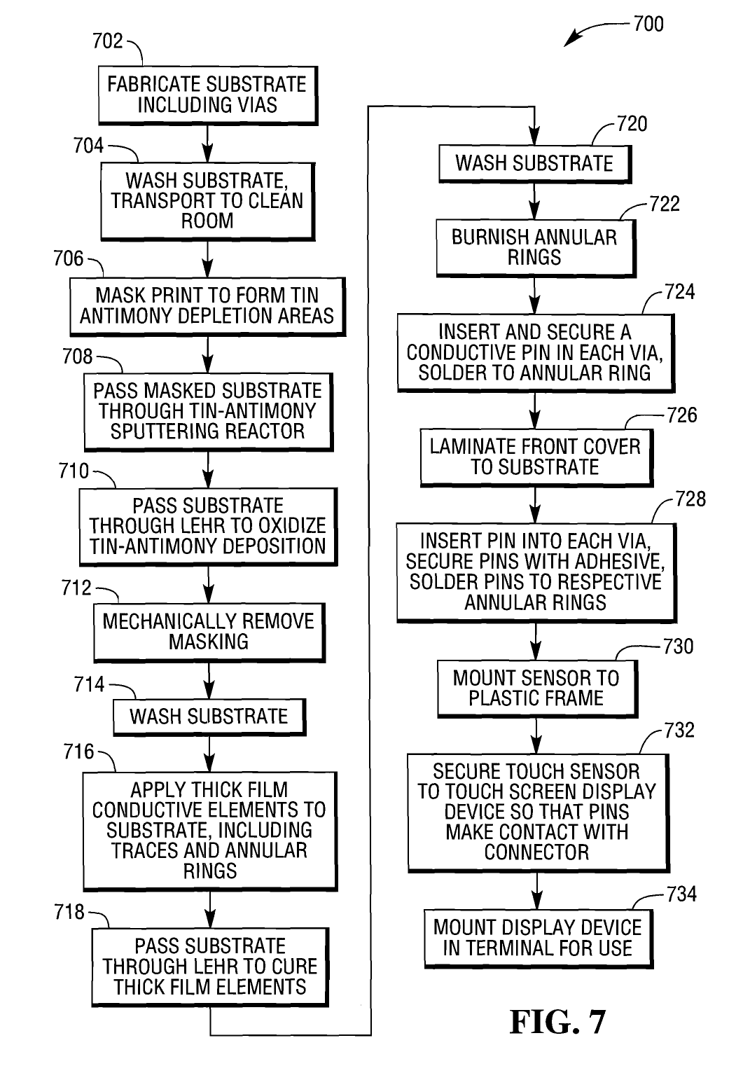

FIG. 7 illustrates the steps of a process 700 of touch sensor fabrication and connection according to an aspect of the present invention. The process 700 is discussed here in connection with a single sensor, but it will be recognized that most of the process steps are undertaken simultaneously as part of a mass production process for fabrication of a number of sensors. At step 702, a suitable substrate, such as glass substrate, for a touch sensor is fabricated, with a plurality of vias passing through the substrate at a desired location or locations, such as at a lower edge. The substrate may suitably be a glass lite, with a plurality of substrates being formed by cutting a sheet of an appropriate glass material, such as raw soda lime float glass, into individual sections, grinding the edges according to desired specifications, and drilling vias at appropriate locations. At step 704, the substrate is washed and transported to a clean room. At step 706, the substrate is mask printed on a screen printer to form tin antimony deletion areas. At step 708, the masked substrate is passed through a tin antimony sputtering reactor. At step 710, the substrate is passed through a lehr so as to oxidize the tin antimony deposition to form tin antimony oxide. At step 712, the masking is mechanically removed, for example, through an abrasive wash with detergent. At step 714, the substrate is washed. At step 716, conductive elements are applied to the substrate, through thick film screen printing of an electrode pattern, conductors, and pads, with the electrodes and conductors suitably being silver frit traces. The conductive elements include a trace from each corner of the area to be used as the touch area of the touch screen to a corresponding via, with an annular ring surrounding the via and connected to the trace. At step 718, the substrate is passed through a lehr to cure the thick film elements. At step 720, the substrate is washed. At step 722, the annular rings are burnished. At step 724, a pin is inserted into and secured in each via, and soldered to the annular ring surrounding the via. At step 726, a protective front surface cover is prepared and laminated to the substrate. At step 728, the substrate and cover are mounted to a plastic frame. At step 730, the substrate and cover, which may now be referred as a sensor, are mounted to a plastic frame. At step 732, the touch sensor is suitably secured to a display device in such a way that the pins make electrical contact with an elastomeric connector secured to the display device, with the elastomeric connector providing electrical connectivity between the pins and a touch screen controller. Mounting of the touch sensor so as to achieve contact between the pins and the elastomeric connector is assisted by registration and alignment features of the plastic frame. At step 734, the display device is suitably mounted in an appropriate terminal or other device for use.

I claim:

1. A touch screen display sensor, comprising:
a substrate;
a conductive material on a top surface of the substrate for producing current flow upon touching of a surface of the sensor;
one or more conductive elements on the top surface of the substrate for conducting current along desired paths to desired points on the substrate; and
one or more contact elements passing through the substrate to carry current from the conductive elements from the top surface of the substrate to an underside of the substrate.

2. The touch screen display sensor of claim 1 wherein each of the contact elements comprises via passing through the substrate, with an electrically conductive pin secured within the via.

3. The touch screen display sensor of claim 2, wherein each of the contact points comprises an annular ring surrounding an opening of each via.

4. The touch screen display of claim 2, wherein each of the conductive elements extends to one of the annular rings.

5. The touch screen display of claim 4, wherein each one of the conductive elements extends from a respective corner of a touch area of the touch screen display sensor to a respective one of the contact elements.

6. The touch screen display sensor of claim 3, wherein an upper portion of each pin is soldered to the annular ring surrounding the opening of the via in which the pin is secured.

7. The touch screen display sensor of claim 2, wherein each of the pins is secured so as to extend approximately 1 mil past the openings of the via on each side of the medium.

8. The touch screen display sensor of claim 2, wherein each of the pins is a gold plated beryllium-copper pin.

9. A method of fabricating a touch screen display device, comprising:
forming one or more vias in a substrate;
coating a top surface of the substrate with a conductive coating such that a touch to the top surface will cause a current flow in the conductive coating;
placing one or more conductive elements on the top surface of the substrate, each of the one or more conductive elements carrying current along a desired path on the top surface of the substrate to a respective one of the one or more vias; and
placing a conductive pin in each via so that current flowing to the via along the top surface of the substrate will be carried by the conductive pin to an underside of the substrate.

10. The method of claim 8, wherein the step of forming the one or more vias is followed by a step of forming an annular ring around an opening of each of the vias, with a trace extending from each annular ring to an edge of the medium.

11. The method of claim 9, wherein the step of placing the pins in the one or more vias includes soldering each pin to the annular ring surrounding an opening of the via in which the pin is secured.

12. The method of claim 9, wherein the pins are secured in the vias in such a way as to extend approximately 1 mil past the openings of the vias on each side of the medium.

11. The method of claim 9, further including the step of mounting the substrate so that the contact pins come in contact with a connector providing connectivity to a touch screen controller.

12. The method of claim 11, wherein the connector is an elastomeric connector.

13. The method of claim 9, further comprising a step of mounting the substrate in a frame.

14. The method of claim 9, wherein the step of placing a conductive pin in each via is preceded by a step of coating an underside of the substrate with a conductive coating.
